(19) United States
(12) Patent Application Publication
(10) Pub. No.: US 2011/0058506 A1
(43) Pub. Date: Mar. 10, 2011

(54) DEVICE AND METHOD FOR TRANSMITTING CHANNEL INFORMATION IN WIRELESS COMMUNICATION SYSTEM

(75) Inventors: Jung-Woo Lee, Seoul (KR); Jian-Jun Li, Gyeonggi-do (KR)

(73) Assignees: SEAH NETWORKS CO., LTD., SEOUL (KR); SNU R & DB FOUNDATION, SEOUL (KR)

(21) Appl. No.: 12/991,102

(22) PCT Filed: May 4, 2009
(86) PCT No.: PCT/KR09/02359

§ 371 Date: Nov. 4, 2010

(30) Foreign Application Priority Data
May 4, 2008 (KR) 10-2008-0041609

(51) Int. Cl. H04J 3/00; H04L 27/00

(52) U.S. Cl. 370/280; 375/295

(57) ABSTRACT

This invention relates to a device and a method for transmitting channel information in a wireless communication system. The disclosed device and method are characterized by: estimating channels by dividing the channel matrix elements for a complex channel into a real number part and an imaginary number part; quantizing each channel which is estimated through the division into the real and imaginary number parts based on a preset boundary value; generating the channel information corresponding to the quantization value for the real and imaginary number parts of the channel matrix elements; and transmitting the generated channel information to a transmitter.

### TECHNICAL FIELD

The present invention relates to a device and method for transmitting channel information in a wireless communication system and, in particular, to a device and method for transmitting channel information obtained by quantizing the Frequency Division Duplex (FDD) downlink channel in a Multi user Multiple Input Multiple Output (MIMO) system based on an Orthogonal Frequency Division Multiple Access (OFDMA) scheme.

### BACKGROUND ART

MIMO is an advanced antenna system using multiple transmission and reception antennas, and various researches have been done for improving the communication capacity of the MIMO-based communication systems.

The MIMO systems can be divided into two structures: open loop MIMO in which transmission is done with no specific channel information and closed loop MIMO in which transmission is done with reference to the channel information fed back from the receiver. The open loop MIMO is implemented with a complex space-time coding scheme to achieve the transmission rate close to the theoretical channel capacity and hence the decoding complexity increases system complexity increases exponentially with the increase of the number of antennas. Accordingly, in reality the closed loop MIMO, in which each transmission antenna has an independent modulation and coding scheme according to channel state, is preferable to achieve the theoretical capacity of the open loop MIMO.

The conventional feedback methods for transmitting the channel information from a receiver to a transmitter in closed loop MIMO are exemplarily described hereinafter.

The first approach is to use a code book. In this case, the receiver estimates the channel and sends an index of a codeword selected from the code book shared between the transmitter and receiver based on an appropriate metric to the transmitter. In the IEEE 802.16e standard, the receiver performs a Singular Value Decomposition (SVD) on a channel matrix H to obtain a precoding matrix V as shown in equation (1). For reference, SVD decomposes the channel matrix H into 2 unitary matrices U and V and a diagonal matrix S, where U is a unitary matrix of left eigenvectors of H, V is a unitary matrix of right eigenvectors of H, and S is a diagonal matrix of eiganvalues of H.

H=U S V^{H} (1)

The receiver compares the precoding matrix V with respective codewords and feeds backs an index of the corresponding codeword to the transmitter. Here, the codeword index consists of 3 or 6 feedback bits per subcarrier.

This approach is advantageous with the small number of feedback bits, however, performing SVD on the channel matrix and repeated codeword comparison results in computational overload of the receiver.

The second approach is to use a sounding signal. This approach can be considered under the assumption of the reciprocity of downlink and uplink channels. The receiver sends a sounding signal to the transmitter through a sounding channel and the transmitter estimates the uplink channel based on the sounding signal and then obtains downlink channel information. This method is appropriated for the Time Division Duplex (TDD) system in which the uplink and downlink channels are reciprocal in the same frequency band but not for the Frequency Division Duplex (FDD) system in which different frequency bands are used for the uplink and downlink channels.

Meanwhile, IEEE 802.16m system, as the next generation communication system, support FDD as well as TDD, whereby there is a need to develop an efficient channel information feedback method for supporting the FDD operational mode that is capable of reducing the computation complexity of the receiver without degradation of the system performance in the OFDMA-based multi user MIMO system.

### DISCLOSURE

### Technical Problem

Therefore, the present invention has been made in view of the above-mentioned problems, and it is an object of the present invention to provide a channel information transmission device and method that is capable of supporting FDD mode in a multi user MIMO system.

It is another object of the present invention to provide a channel information transmission device and method that is capable of feeding back the quantized channel information to the transmitter.

It is still another object of the present invention to provide a device and method that is capable of feeding back only the differential information indicating difference between the current channel information and the previous channel information, thereby reducing feedback data amount and improving system performance.

### Technical Solution

According to one aspect of the present invention, there is provided a device for transmitting channel information of complex channels established between a transmitter and a receiver in a wireless communication system, comprising: a channel estimator for estimating a channel by decomposing a channel matrix element on a complex channel into a real part and an imaginary part: a channel quantizer for outputting quantization values by quantizing the real part and the imaginary part based on predetermined boundary values, respectively; a channel information generator for generating channel information corresponding to the quantization values of the real part and the imaginary part; and a channel information transmitter for transmitting the channel information.

According to another aspect of the present invention, there is provided a method for transmitting channel information of a complex channel established between a transmitter and a receiver in a wireless communication system, comprising: estimating a channel by decomposing a channel matrix element of the complex channel into a real part and an imaginary part; quantizing the real part and imaginary part of the estimated channel based on predetermined boundary values; generating channel information corresponding to the quantization results of the real part and imaginary part; and transmitting channel information.

According to further another aspect of the present invention, there is provided a device for transmitting channel information in a wireless communication system supporting Multi user Multiple Input Multiple Output (MU MIMO) based on Frequency Division Duplex (FDD), comprising: a channel estimator for estimating a channel from an FDD downlink signal: a channel information generator for generating channel information by quantizing a element of a channel matrix; and a channel information transmitter for feeding back the channel information.

According to still further another aspect of the present invention, there is provided a method for transmitting channel information in a wireless communication system supporting Multi user Multiple Input Multiple Output (MU MIMO) based on Frequency Division Duplex (FDD), comprising: estimating a channel from an FDD downlink signal; generating channel information by quantizing an element of the channel; and feeding back the channel information.

### Advantageous Effects

The channel information transmission device and method feeds back the channel information generated by quantizing a real part and an imaginary part of a channel matrix element in a multi user MIMO system, thereby reducing computation amount of the receiver and being able to implement effective feedback scheme supporting FDD.

The channel information transmission device and method calculates optimized boundary values using Gaussian distribution and quantizes the channel matrix elements based on the boundary values, thereby reducing feedback data without compromising system performance.

The channel information transmission device and method feeds back only the differential information indicating difference between the current channel information and the previous channel information, thereby reducing feedback data amount and improving system performance.

### DESCRIPTION OF THE DRAWINGS

FIG. 1 is a schematic diagram illustrating a multi user MIMO which is applicable to the present invention;

FIG. 2 is a block diagram illustrating a configuration of a channel information transmission device according to a first embodiment of the present invention

FIG. 3 is a graph illustrating how to quantize a real part and an imaginary part of complex channel matrix element with 2 bits respectively using Gaussian distribution.

FIG. 4 shows graphs illustrating BER vs. SNR performances in a single user environment and a multi user environment according to the variation of a number of quantization hits;

FIG. 5 is a block diagram illustrating a configuration of a channel information transmission device according to a second embodiment of the present invention;

FIG. 6 is a graph illustrating sum capacity vs. SNR performance when quantized with 8 bits in rectangular coordinate and polar coordinate schemes;

FIG. 7 is a flowchart illustrating a channel information transmission method according to a first embodiment of the present invention;

FIG. 8 is a flowchart illustrating a channel information transmission method according to a second embodiment of the present invention; and

FIG. 9 is a flowchart illustrating a procedure for calculating boundary values for quantization using Gaussian distribution.

### MODE FOR INVENTION

Exemplary embodiments of the present invention are described with reference to the accompanying drawings in detail. Detailed descriptions of well-known functions and structures incorporated herein may be omitted to avoid obscuring the subject matter of the present invention.

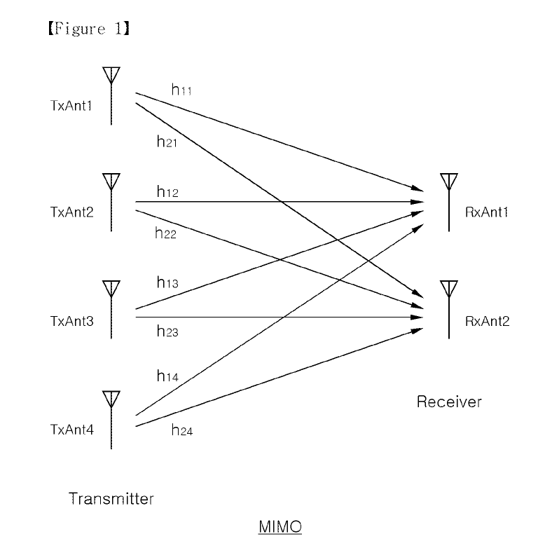

FIG. 1 is a schematic diagram illustrating a MIMO system to adopt a channel information transmission method according to an exemplary embodiment of the present invention. In a MIMO system, the transmitter and receiver communicate with each other through multiple communication channels established between their multiple transmit and receive antennas. FIG. 1 shows the exemplary 4×2 MIMO system including a transmitter with 4 transmit antennas (TxAnt1, TxAnt2, TxAnt3, and TxAnt4) and a receiver with 2 receive antennas (RxAnt1 and RxAnt2) establishing 8 communication channels (h₁₁, h₁₂, h₁₃, h₁₄, h₂₁, h₂₂, h₂₃, and h₂₄).

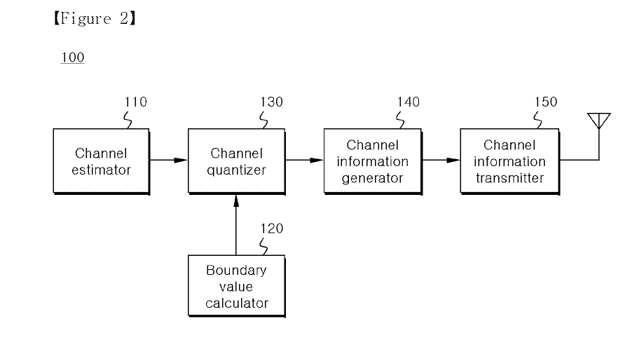

FIG. 2 is a block diagram illustrating a configuration of a channel information transmission device according to a first embodiment of the present invention.

As shown in FIG. 2, the channel information transmission device 100 includes a channel estimator 110, a boundary value calculator 120, a channel quantizer 130, a channel information generator 140, and a channel information transmitter 150.

The channel estimator 110 estimates channels by decomposing each element of the channel matrix of complex channels between the transmitter and the receiver into a real part and an imaginary part. The channel estimation is carried out by sampling the real part and imaginary part of each channel periodically, and the estimated channel value is output to the quantizer 130.

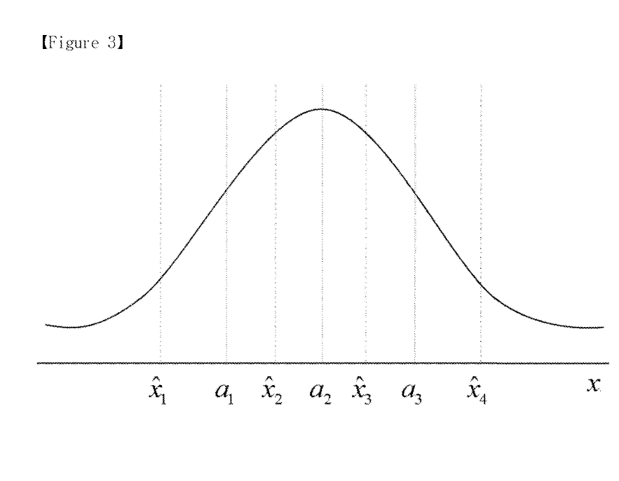

The boundary value calculator 120 calculates the boundary values as reference for quantizing the channel values and outputs the boundary values to the channel quantizer 130. The boundary value calculator 120 calculates and/or stores N−1 boundary values for N quantization levels and outputs the boundary values to channel quantizer 130. How to calculate the boundary values is described with reference to FIG. 3 hereinafter.

In an embodiment of the present invention, the boundary values for quantizing the elements of the channel matrix in the real and imaginary parts are calculated using a probability density function (pdf) and/or a cumulative distribution function (cdf) under the assumption of Gaussian distribution of the complex channel matrix.

In more detail, when the probability variable is denoted by x, the provability density function by ƒₓ(x), the boundary value by a, the quantization value by \hat{x}, the quantization distortion by D, and the quantization level by N, the quantization distortion can be expressed as equation (2).

$$D = {\int }_{- ∞}^{{a}_{1}} {( x - {\hat{x}}_{1} )}^{2} {f}_{x} ( x ) d x + {\sum }_{i = 1}^{N - 2} {\int }_{{a}_{i}}^{{a}_{i + 1}} {( x - {\hat{x}}_{i + 1} )}^{2} {f}_{x} ( x ) d x + {\int }_{{a}_{N - 1}}^{∝} {( x - {\hat{x}}_{N} )}^{2} {f}_{x} ( x ) d x \qquad ( 2 )$$

In order to derive the condition of aᵢ in which D minimizes, a partial differentiation is taken with respect to aᵢ as indicated by equation (3), resulting in equation (4).

$$\begin{matrix}\frac{\partial }{\partial {a}_{i}} D = {f}_{x} ( {a}_{i} ) [ {( {a}_{i} - {\hat{x}}_{i} )}^{2} - {( {a}_{i} - {\hat{x}}_{i + 1} )}^{2} ] = 0 & ( 3 ) \\ {a}_{i} = \frac{1}{2} ( {\hat{x}}_{i} + {\hat{x}}_{i + 1} ) & ( 4 )\end{matrix}$$

From equation 4, the boundary value aᵢ minimizing quantization distortion D is the mean value of the quantization values (\hat{x}ᵢ, \hat{x}ᵢ₊₁).

Next, in order to obtain the quantization value minimizing D, a partial differentiation is taken with respective to \hat{x}ᵢ as indicated by equation (5), resulting in equation (6).

$$\begin{matrix}\frac{\partial }{\partial {\hat{x}}_{i}} D = {\int }_{{a}_{i - 1}}^{{a}_{i}} 2 ( x - {\hat{x}}_{i} ) {f}_{x} ( x ) d x = 0 & ( 5 ) \\ \begin{matrix}{\hat{x}}_{i} = \frac{{\int }_{{a}_{i - 1}}^{{a}_{i}} {xf}_{x} ( x ) d x}{{\int }_{{a}_{i - 1}}^{{a}_{i}} {f}_{x} ( x ) d x} \\ = \frac{{\int }_{{a}_{i - 1}}^{{a}_{i}} {xf}_{x} ( x ) d x}{P ( {a}_{i - 1} < X \leq {a}_{i} )} \\ = {\int }_{{a}_{i - 1}}^{{a}_{i}} x \frac{{f}_{x} ( x )}{P ( {a}_{i - 1} < X \leq {a}_{i} )} d x \\ = {\int }_{- ∞}^{∞} {xf}_{x} ( x \vert {a}_{i - 1} < X \leq {a}_{i} ) d x \\ = E [ X \vert {a}_{i - 1} < X \leq {a}_{i} ]\end{matrix} & ( 6 )\end{matrix}$$

From equation (6), it is known that the quantization value \hat{x}ᵢ, is a function of the boundary value aᵢ and also is a conditional mean of x over the range (aᵢ₋₁, aᵢ).

The aᵢ and \hat{x}ᵢ are finally obtained by calculating aᵢ and \hat{x}ᵢ iteratively until the significant digit does not change. In this manner, the boundary values and quantization values are determined according to the quantization bits (quantization level) as shown in table 1. In an exemplary embodiment the number of significant digits is 4 below decimal point.

TABLE 1
boundary and quantization values according to number
of quantization bits

| Number of | | |
|---|---|---|
| bits | Boundary value | Quantization value |
| 1 | 0 | ±0.5642 |
| 2 | 0, ±0.6941 | ±0.3202, ±1.0677 |
| 3 | 0, ±0.3540, ±0.7425, ±1.2360 | ±0.1733, ±0.5346, |
| 4 | 0, ±0.1826, ±0.3694, ±0.5654, | ±0.9504, ±1.5217 |
| | ±0.7771, ±1.0161, ±1.3039, ±1.6978 | ±0.0908, ±0.2744, |
| | | ±0.4644, ±0.6664, |
| | | ±0.8881, ±1.1441, |
| | | ±1.4630, ±1.9325 |

The channel quantizer 130 quantizes the estimated channel values output by the channel estimator 110 with reference to the boundary values provided by the boundary value calculator 120. As aforementioned, the quantization is performed on each element of the channel matrix in the real and imaginary parts and the quantized results are output to the channel information generator 140.

The channel information generator 140 generates the channel information by encoding the quantized values output by the channel quantizer 130. Here, the channel information for each element of the channel matrix is generated with the respective real part and the imaginary part encoded into the number of bits corresponding to the quantization level.

For instance, when the quantization level (number of quantization bits) is 4, the channel information generated by the channel information generator 140 and the quantized channel values corresponding to the channel information can be listed as shown in table 2.

TABLE 2
channel information and quantized channel values
with 4 quantization levels

| Channel info. | Quantized channel value |
|---|---|
| (4 bits) | (representative value) |
| 0000 | −1.9325 |
| 0001 | −1.4630 |
| 0010 | −1.1441 |
| 0011 | −0.8881 |
| 0100 | −0.6664 |
| 0101 | −0.4644 |
| 0110 | −0.2744 |
| 0111 | −0.0908 |
| 1000 | 0.0908 |
| 1001 | 0.2744 |
| 1010 | 0.4644 |
| 1011 | 0.6664 |
| 1100 | 0.8881 |
| 1101 | 1.1441 |
| 1110 | 1.4630 |
| 1111 | 1.9325 |

That is, although the channel information is provided as the quantized channel values, the channel information is preferably provided as the indices representing the quantized channel values in the form of a table or base mode codebook as shown in exemplary table 2.

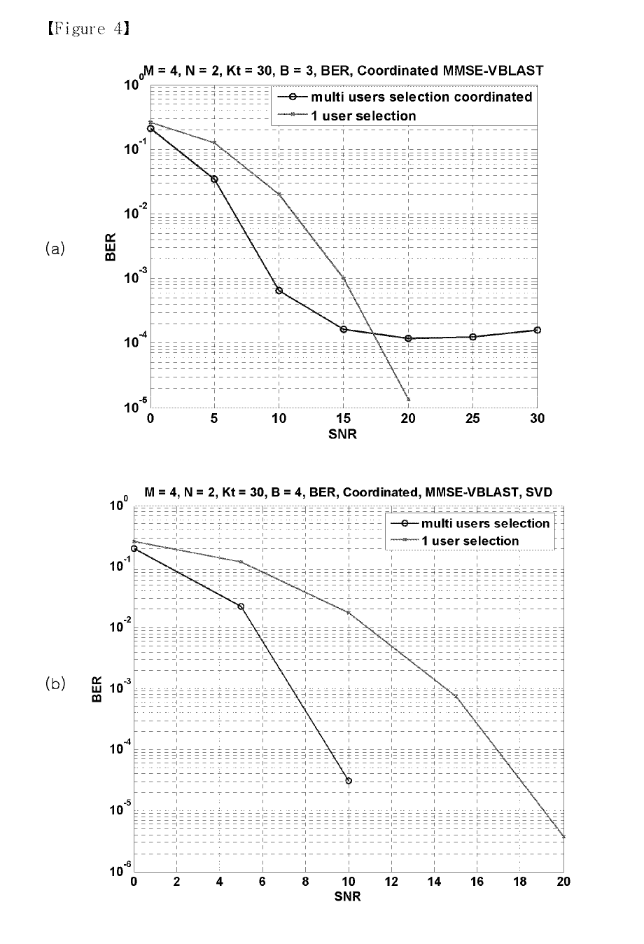

FIG. 4 shows graphs illustrating BER vs. SNR performances in a single user environment and a multi user environment according to the variation of a number of quantization bits.

The graph (a) of FIG. 4 shows the BER (Bit Error Rate) vs. SNR (Signal to Noise Ratio) performance in the single user and multi user environments when the real part and imaginary part of each element of the channel matrix are quantized with 3 bits respectively. As shown in the graph (a), a crossover occurs in the SNR range between 15 and 20 such that the single user environment' s BER becomes lower than the multi user environment's BER.

The graph (b) of FIG. 4 shows the BER vs. SNR performance in the single user and multi user environments when the real part and imaginary part of each element of the channel matrix are quantized with 4 bits respectively. Since no crossover occurs across the entire SNR range in the case, it is preferable to set the number of quantization bits to 4 (total 8 hits per channel) or more.

Finally, the channel information transmitter 150 transmits the channel information to the transmitter through a feedback channel.

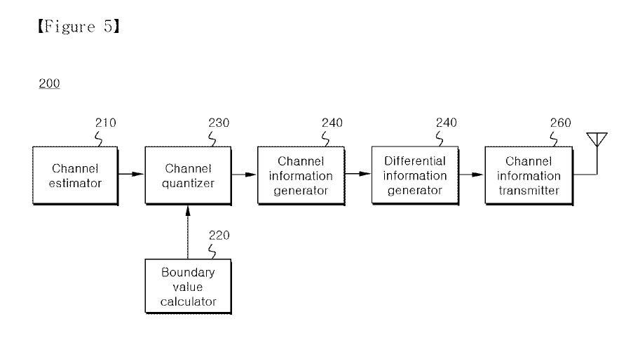

FIG. 5 is a block diagram illustrating a configuration of a channel information transmission device according to a second embodiment of the present invention. In the second embodiment, the receiver transmits differential information indicating difference from the previous channel information rather than transmitting the entire channel information. This is preferable for transmitting the short-term channel information with which the variation of channel status is relatively low.

As shown in FIG. 5, the channel information transmission device 200 according to the second embodiment of the present invention includes a channel estimator 210, a boundary value calculator 220, a channel quantizer 230, a channel information generator 240, a differential information generator 250, and a channel information transmitter 260. Since the channel estimator 210, the boundary value calculator 220, the channel quantizer 230, the channel information generator 240 are substantially identical with those of the channel information transmission device 100 of the first embodiment in structure and function, only the differential information generator 250 and the channel information transmitter 260 are described in detail hereinafter.

The differential information generator 250 compares the current channel information output by the channel information generator 240 with the previous channel information and generates the differential information based on the difference between the current and previous channel information. For this purpose, the differential information generator 250 can be provided with a buffer for temporarily storing the previous channel information provided by the channel information generator 240 so as to generate the differential information by comparing the current channel information output by the channel information generator 240 and the previous channel information stored in the buffer.

In case of 8-bit channel information including respective 4 real part quantization bits and 4 imaginary part quantization bits, the initial 8-bit channel information has no previous channel information. Accordingly, the differential information generator 250 generates the initial 8-bit channel information as the differential information (in this case, the buffer is set to 0) and stores the initial 8-hit channel information into the buffer. Once the initial 8-bit channel information is stored in the buffer, the differential information generator 250 compares the current channel information with the previous channel information and generates the differential information of 1 or 2 bits (2 to 4 bits per channel).

Here, the differential channel information can be implemented for leveling up or down (e.g. the differential channel information bit can be set to ‘1’ for leveling up and ‘0’ for leveling down) or in the form of an index indicating the channel information listed in a differential mode codebook .

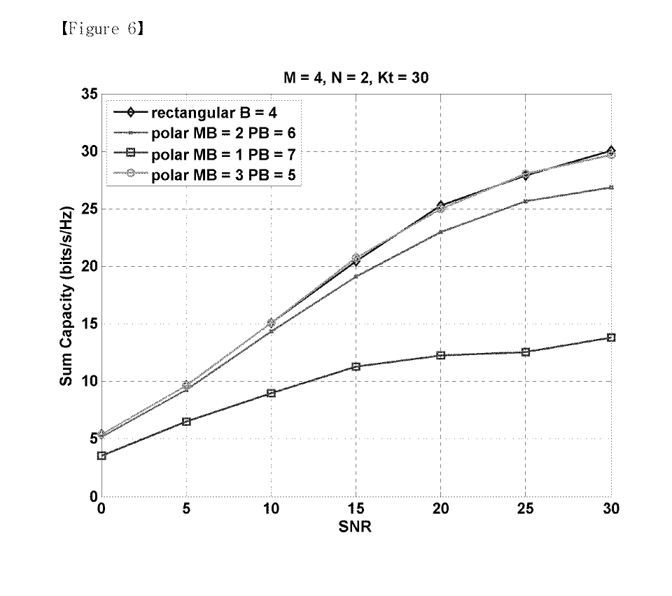

FIG. 6 is a graph illustrating sum capacity vs. SNR performance when quantized with 8 bits in rectangular coordinate and polar coordinate schemes. In FIG. 6, the rectangular coordinate scheme shows the best performance when the real part and the imaginary part are quantized with 4 bits respectively, and the polar coordinate scheme shows its performance similar to that of the rectangular coordinate scheme when each element of the channel matrix is quantized with 5-bit phase and 3-hit magnitude. Since the calculation amount for obtaining the real part and the imaginary part of the channel matrix element is less than that for obtaining the phase and magnitude, the rectangular coordinate scheme-based method as adopted to the present invention is more practical in reality.

The channel information transmitter 260 transmits the differential information to the transmitter through a feedback channel. As aforementioned, the entire channel information, e.g. 8-bit channel information, is transmitted in an initial feedback stage, and then the 2 to 4-hit differential information is transmitted.

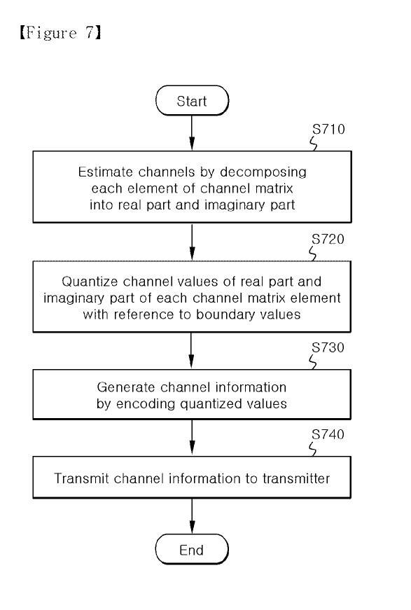

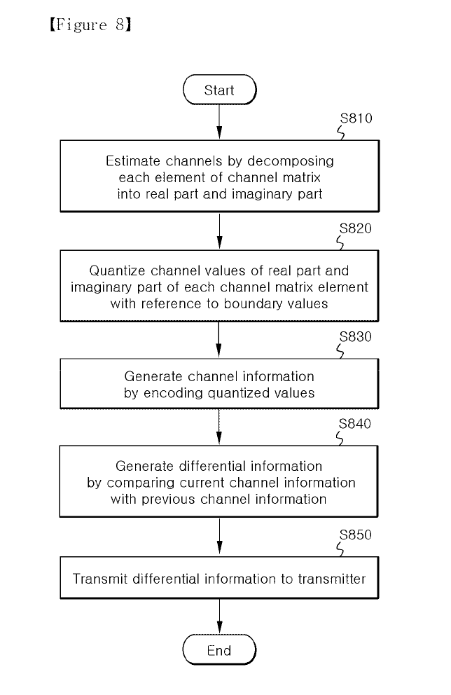

The channel information transmission method according to an exemplary embodiment of the present invention is described hereinafter with reference to FIGS. 7 and 8.

Detailed descriptions of procedures and operations of the channel information transmission method that have been described already in association with the channel information transmission device may be omitted.

FIG. 7 is a flowchart illustrating a channel information transmission method according to a first embodiment of the present invention.

Referring to FIG. 7, a receiver decomposes each element of the channel matrix of complex channels established with a transmitter into a real part and an imaginary part and estimates the channel with the real part and the imaginary part of the channel at step S710. Next, the receiver quantizes the channel values of the real part and the imaginary part of the channel matrix element with reference to the boundary values at step S720. The boundary values are preferably obtained using Gaussian distribution.

Next, the receiver generates channel information composed of a predetermined number of bits by encoding the quantized real part value and imaginary value at step S730. Finally, the receiver transmits the channel information to the transmitter at step S740.

FIG. 8 is a flowchart illustrating a channel information transmission method according to a second embodiment of the present invention. In this embodiment, differential information is transmitted as the channel information.

Referring to FIG. 8, the receiver decomposes each element of the channel matrix into a real part and an imaginary part and estimates the channel with the real part and the imaginary part of the channel at step S810. Next, the receiver quantizes channel values of the real part and the imaginary part of the channel matrix element with reference to the boundary values at step S820. Next, the receiver generates channel information composed of a predetermined number of bits by encoding the quantized real part value and imaginary value at step S830.

Sequentially, the receiver compares the current channel information with the previous channel information to output differential information at step S840. In this embodiment, the initial channel information is regarded as the differential information. Finally, the receiver transmits the differential information to the transmitter at step S850. At the initial feedback stage the initial channel information is transmitted, and differential information is transmitted from the next feedback stage.

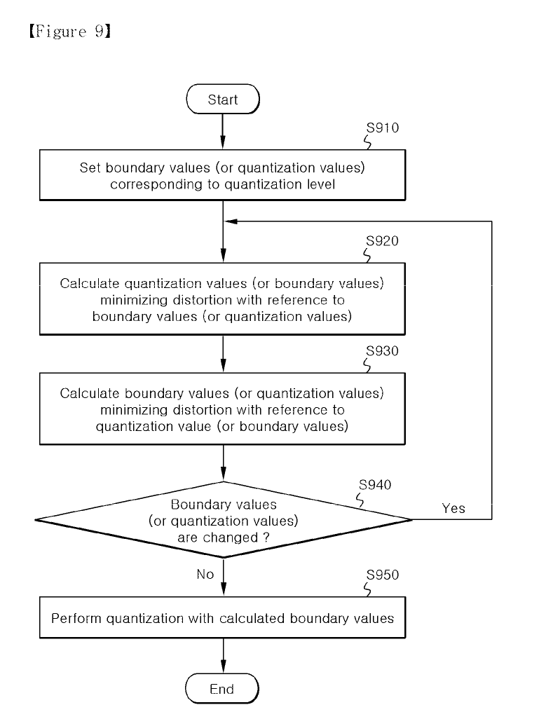

FIG. 9 is a flowchart illustrating steps of quantization procedure of the channel information transmission methods of FIGS. 7 and 8. This procedure can be explained with reference to the description about the boundary value generators 120 and 220.

The receiver first sets quantization values corresponding to the number of quantization levels at step S910. When using 4 quantization levels as shown in FIG. 3, 3 boundary values a₁, a₂, and a₃ are set. Next, the receiver calculates the quantization values \hat{x}₁, \hat{x}₂, \hat{x}₃, and \hat{x}₄ that minimize the quantization distortion D with reference to the boundary values (see equations (5) and (6)) at step S920. Next, the receiver calculates the boundary values a₁, a₂, and a₃ with reference to the quantization values \hat{x}₁, \hat{x}₂, \hat{x}₃, and \hat{x}₄ (see equations (3) and (4)) at step S930. Next, the receiver compares the calculated boundary values with the previously calculated boundary values at step S940. It is preferred that the identification test is performed to the significant digits. When the current boundary values and the previous boundary values are not identical with each other, the receiver repeats steps S920 and S930 to calculate the quantization values and boundary values. The steps S910 to S940 can be rearranged such that the receiver determines the quantization values first and then calculate the final boundary values through iterative boundary values and quantization values calculations. When the current boundary values and the previous boundary values are identical with each other at step S940, the receiver performs the quantization process with the finally calculated boundary vales at step S950.

For reference, the channel information transmission device and method according to the present invention exemplify quantization scheme in which the real part and the imaginary part of each channel element are encoded with 4 bits respectively. As described above, the channel information transmission device and method according to the present invention can reduce the number of bits of channel information without compromising the system performance by quantizing the real part and the imaginary part of each channel element with 8 bits (4 hits for real part and 4 bits for imaginary part).

In case of 4×2 MIMO system as exemplarily shown in FIG. 1, the receiver transmits 32-bit channel information for 4 channels through each transmit antenna, and it is observed that the feedback performance of this system substantially equals to that of the codebook-based channel information feedback in which 17-bit channel information it transmitted. In consideration of the computation complexity (SVD and repeated codeword comparison) of the codebook based feedback in the receiver, the channel information transmission method according to the present invention is more efficient than the codebook based channel information transmission method.

Particularly in a Collaborative MIMO system which is implemented with a base station having multiple antenna and multiple mobile terminals each having a single antenna, since each mobile terminal uses a single antenna, the channel information transmission method according to the present invention can dramatically reduce the feedback information of the mobile terminal relatively to the case that a mobile terminal uses multiple antenna.

While the invention has been shown and described with reference to certain exemplary embodiments thereof, it will be understood by those skilled in the art that various changes in form and details may he made therein without departing from the spirit and scope of the invention. Therefore, the spirit and scope of the present invention must be defined not by described embodiments thereof but by the appended claims and equivalents of the appended claims.

1. A device for transmitting channel information of complex channels established between a transmitter and a receiver in a wireless communication system, comprising:
a channel estimator for estimating a channel by decomposing a channel matrix element on a complex channel into a real part and an imaginary part;
a channel quantizer for outputting quantization values by quantizing the real part and the imaginary part based on predetermined boundary values, respectively;
a channel information generator for generating channel information corresponding to the quantization values of the real part and the imaginary part; and
a channel information transmitter for transmitting the channel information.

2. The device of claim 1, wherein the boundary values are calculated using Gaussian distribution.

3. The device of claim 2, wherein the channel information corresponding to each of the real part and the imaginary part is 4 bits.

4. The device of claim 1, further comprising:
a differential information generator for generating differential information by comparing current channel information with previous channel information and outputting the differential information to the channel information transmitter.

5. The device of claim 4, wherein the differential information is information on a short-term channel.

6. The device of claim 1, wherein the complex channel is a downlink channel of a Frequency Division Duplex (FDD) system.

7. The device of claim 1, wherein the communication system is a Multi user Multiple Input Multiple Output (MU MIMO) system.

8. A method for transmitting channel information of a complex channel established between a transmitter and a receiver in a wireless communication system, comprising:
estimating a channel by decomposing a channel matrix element of the complex channel into a real part and an imaginary part;
quantizing the real part and imaginary part of the estimated channel based on predetermined boundary values;
generating channel information corresponding to the quantization results of the real part and imaginary part; and
transmitting channel information.

9. The method of claim 8, wherein the boundary values are calculated using Gaussian distribution.

10. The method of claim 8, further comprising:
generating differential information by comparing current channel information and previous channel information after generating the channel information, wherein the channel information is transmitted for a first feedback and the differential information is transmitted after the first feedback.

11. The method of claim 8, wherein the complex channel is a downlink channel of a Frequency Division Duplex (FDD) system.

12. The method of claim 8, wherein the communication system is a Multi user Multiple Input Multiple Output (MU MIMO) system.

13. A device for transmitting channel information in a wireless communication system supporting Multi user Multiple Input Multiple Output (MU MIMO) based on Frequency Division Duplex (FDD), comprising:
a channel estimator for estimating a channel from an FDD downlink signal;
a channel information generator for generating channel information by quantizing a element of a channel matrix; and
a channel information transmitter for feeding back the channel information.

14. The device of claim 13, wherein the channel information generator decomposes the element of the channel matrix into a real part and an imaginary part and quantizes the respective real part and imaginary part using boundary values.

15. The device of claim 14, wherein the boundary values are calculated using Gaussian distribution.

16. The device of claim 13, wherein the channel information is an index representing a quantized channel value or an index of a base mode codebook for channel information.

17. The device of claim 13, further comprising:
a differential information generator for generating differential information by comparing current channel information with previous channel information and outputting the differential information to the channel information transmitter.

18. The device of claim 17, wherein the differential information is information on a short-term channel.

19. The device of claim 13 is a mobile terminal.

20. A method for transmitting channel information in a wireless communication system supporting Multi user Multiple Input Multiple Output (MU MIMO) based on Frequency Division Duplex (FDD), comprising:
estimating a channel from an FDD downlink signal;
generating channel information by quantizing an element of the channel; and
feeding back the channel information.

21. The method of claim 20, wherein generating channel information comprises quantizing the element of the channel into a real part and an imaginary part.

22. The method of claim 21, wherein quantizing the element of the channel is performed with reference to boundary values calculated using Gaussian distribution.

23. The method of claim 20, wherein the channel information is an index representing a quantized channel value or an index of a base mode codebook for channel information.

24. The method of claim 20, further comprising:
generating differential information by comparing current channel information with previous channel information, wherein the channel information is transmitted for a first feedback and the differential information is transmitted after the first feedback.

25. The method of claim 24, wherein the differential information is index of a differential mode codebook for the channel information.
